(19) United States
(12) Patent Application Publication
(10) Pub. No.: US 2010/0220461 A1
(43) Pub. Date: Sep. 2, 2010

(54) DISPLAY DEVICE, CAP, LIGHT-EMITTING DEVICE AND METHOD OF MANUFACTURING THE SAME

(75) Inventor: Shuichi Naijo, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Minato-ku (JP)

(21) Appl. No.: 12/303,316

(22) PCT Filed: Jun. 5, 2008
(86) PCT No.: PCT/JP2008/060347

§ 371 Date: Dec. 3, 2008

(30) Foreign Application Priority Data
Jun. 7, 2007 (JP) 2007-151187

(51) Int. Cl. G09F 13/08; F21V 7/10; H01K 1/30; F21K 99/00; H01J 9/26; B29D 11/00

(52) U.S. Cl. 362/97.1; 362/341; 313/113; 362/241; 362/231; 445/44; 264/1.9

(57) ABSTRACT

There is provided a LED substrate 12; a light-emitting diode (LED) 21 that is mounted on the LED substrate 12; a cap 50 that is attached to the LED substrate 12 and that covers the light-emitting diode (LED) 21. The cap 50 has a reflector portion 52 of a width from a side of the cap 50, which is attached to the LED substrate 12, and has a lens portion 51 continuous with the reflector portion 52. The reflector portion 52 and the lens portion 51 are formed integrally with each other. By this configuration, a light-reflecting function and a light-refracting function that the cap has are achieved by a simple structure of a backlight device using a solid-state light-emitting element such as a LED.

### TECHNICAL FIELD

The present invention relates to a light-emitting device such as a backlight including a cap configuration at, for example, a light source portion, also relates to a display device having a backlight, and the like.

### BACKGROUND ART

Recently, display devices such as liquid crystal display devices, typified by, for example, a liquid crystal display television and a liquid crystal display monitor, have adopted a backlight as a light-emitting device for emitting light from the back, side or the like of a display panel. As the backlight, what is called a direct-lighting type exists in which a light source is disposed on a plane surface beneath the liquid crystal panel (a rear surface), for example. In addition, what is called an edge-lighting type also exist in which a light source is disposed on two or one side of a light guide plate made of a transparent resin so that light incident on the light guide plate is reflected by a reflector disposed on the back surface of the light guide plate, thus illuminating, for example, the surface of a liquid crystal display panel. Here, the direct-lighting type has an advantage of securing high brightness, but has a disadvantage of difficulty in achieving a thinner backlight. On the other hand, the edge-lighting type has an advantage of achieving a thinner backlight than the direct-lighting type, but has a disadvantage of difficulty in obtaining evenness of the brightness for a large display.

A fluorescent tube such as a hot-cathode fluorescent tube or a cold-cathode fluorescent tube is generally used as the above-mentioned backlight device. On the other hand, technologies of backlight device using light-emitting diodes (LEDs), which are one type of light-emitting elements, as a light source, have been recently developed as a substitute for the backlight devices using the fluorescent tubes.

Here, the backlight device is provided with a reflection plate (a reflector) that reflects light emitted from, for example, an LED toward an observer, and the reflector reflects, for example, light emitted in a side direction so that the light exits from a top surface. Also, a cap having a lens function as necessary is often used for the purpose of sealing the LED or of focusing light emitted from an LED light source and thereby performing any given control on, for example, luminous intensity distribution.

Related arts disclosed in Official Gazette include one adopting a sawtooth-shaped lens that refracts light emitted from an LED light source. Here, light is efficiently coupled to a reflector of shallow depth and a thin light guide, thereby providing a relatively large range of irradiation to a secondary optical element (for example, refer to Patent Document 1).

Patent Document 1: Japanese Patent Application Laid Open Publication No. 2003-8068

### DISCLOSURE OF THE INVENTION

### Problems to be Solved by the Invention

As mentioned above, the reflector and the cap are often combined to be used with the LED light source. However, if the reflector and the cap are formed separately and are used in combination, the formation of each member requires advanced technology, and moreover, it is required that these members be combined with high positioning accuracy. Further, the formation and combination of these members require many working processes, thus leading to a rise in manufacturing costs, and in turn to a rise in product costs.

The present invention has been made in order to address the foregoing technological problems. An object of the present invention is to achieve a light reflection function and a light transmission function possessed by a cap with a simple structure in alight-emitting device using a solid-state light-emitting element such as an LED.

### Means for Solving the Problems

In order to address the above object, according to the present invention, there is provided a display device including a display panel that displays an image, and a backlight disposed on a back side of the display panel and irradiating the display panel with light from the back side of the display panel. The backlight is provided with: a solid-state light-emitting element; and a cap that covers the solid-state light-emitting element, and the cap has a light reflection portion that reflects light from the solid-state light-emitting element, and a light transmission portion that transmits light from the solid-state light-emitting element toward the display panel. The light reflection portion and the light transmission portion are integral with each other.

Here, the cap forms a dome shape having an end and a ceiling, the light reflection portion is provided to have a width from the end of the dome shape, and the cap is mounted on a mounting substrate with the end of the dome shape fixedly bonded to the mounting substrate on which the solid-state light-emitting element is mounted, in order to easily fix the cap to the mounting substrate with a bonding layer provided at, for example, a lower part of the light reflecting portion.

On the other hand, the cap to which the present invention is applied having an opening end and a ceiling, and forming a hollow shape. The cap includes: a light reflection portion that is provided to have a width from the end toward the ceiling; and a light transmission portion that is provided toward the ceiling, and that is continuous with the light reflection portion.

Here, other than a hemispherical shape, the external shape of the cap may be any of various cubes, a shape of sawtooth as shown in FIG. 5E and so on of the above patent document 1, a shape of funnel, or the like. The external shape may be of any shape, and it is preferable that the cap have an opening end and a ceiling and a hollow portion capable of fitting the solid-state light-emitting element therein. Such shapes may be herein called a “dome shape.”

Also, the reflectance of a light reflector and the transmittance of a light transmitter may be defined as total transmittance and total reflectance based on a testing method for optical properties based on JISK7105. In other words, it is preferable that the light reflector is made of a white resin so that its total reflectance may be equal to or more than 60% (based on the JISK7105 testing method). Also, it is preferable that the light transmitter is made of a transparent resin so that its transmittance may be equal to or more than 70% (based on the JISK7105 testing method), or more preferably is equal to or more than 80% (based on the JISK7105 testing method). Then, the cap to which the present invention is applied may be configured of the white resin integral with the transparent resin.

According to another aspect of the present invention, there is provided a light-emitting device to which the present invention is applied including: a mounting substrate; a solid-state light-emitting element that is mounted on the mounting substrate; and a cap that is attached to the mounting substrate and that covers the solid-state light-emitting element. The cap has a light reflection portion of a width from a side of the cap, the side being attached to the mounting substrate, and has a light transmission portion continuous with the light reflection portion. The light reflection portion and the light transmission portion are formed integrally with each other.

Here, the light reflection portion of the cap is provided with a reflection film.

Further, a plurality of the solid-state light-emitting elements are mounted on the mounting substrate, and the cap is attached to each of the plurality of the solid-state light-emitting elements.

Furthermore, a plurality of the solid-state light-emitting elements are mounted on the mounting substrate. Each solid-state light-emitting element has, as a unit, at least three LEDs (light-emitting diodes) included in a plurality of LEDs each emitting red, green, or blue light, and the cap is attached to each unit of the solid-state light-emitting elements having at least the three LEDs as the unit.

According to further aspect of a present invention from a standpoint of a category of a manufacturing method, there is provided a method of manufacturing a backlight device to which the present invention is applied, including: placing a cap on a mounting substrate having a solid-state light-emitting element mounted thereon, with its end in contact with the mounting substrate, the cap having, as an external shape, a dome shape with a hollow portion, and having a light reflection portion that reflects light from the solid-state light-emitting element and a light transmission portion that transmits light from the solid-state light-emitting element, the light reflection portion and the light transmission portion being integral with each other, the light reflection portion having high reflectance with a width from an end of the external shape; and injecting a curing liquid resin into a void formed by the hollow portion of the cap and the mounting substrate, and then curing the liquid resin.

Here, the injection of the liquid resin is performed through a resin injection port penetrating a surface of the mounting substrate opposite to a mounting surface on which the solid-state light-emitting element is mounted and a region of the mounting surface where the void is formed, and the liquid resin, including the resin within the resin injection port, is cured.

According to a furthermore aspect of the present invention, there is provided a method of manufacturing a cap for covering a solid-state light-emitting element, including: forming a light transmission portion that forms a hollow and that has a ceiling and an end by injecting a first liquid resin into a mold; and forming a light reflection portion continuous with the end of the light transmission portion by injecting, into a mold, a second liquid resin having higher light reflectance than the first liquid resin after forming the light transmission portion, thereby forming the cap having the light reflection portion that reflects light from the solid-state light-emitting element and the light transmission portion that transmits light from the solid-state light-emitting element. The light reflection portion and the light transmission portion are integral with each other.

### ADVANTAGES OF THE INVENTION

According to the present invention having the above-mentioned configuration, it is possible to considerably reduce a manufacturing process of the backlight device, for example.

### BEST MODES FOR CARRYING OUT THE INVENTION

Hereinafter, exemplary embodiments of the present invention will be described in detail with reference to the accompanying drawings.

FIG. 1 is an entire configuration of a liquid crystal display device to which an exemplary embodiment is applied. The liquid crystal display device to which the present exemplary embodiment is applied, as a direct lighting type backlight device (backlight) 10, includes a backlight frame 11 that contains a light-emitting portion, and a LED substrate (mounting substrate) 12 as a substrate on which plural light-emitting diodes (LEDs, LED chips) that are one type of a solid-state light-emitting element as a light-emitting source are arrayed. Moreover, the backlight device 10 includes, as a laminated body of optical films, a diffusion plate 13 for scattering and diffusing light to equalize the lightness over the entire surface, and prism sheets 14 and 15 as a diffraction grating film that has a light collection effect to the front. Incidentally, the backlight device 10 may further include a brightness improvement film with a diffusion and reflection type, for improving the brightness. However, it is not shown in the figure.

On the other hand, a liquid crystal display module 30 includes a liquid crystal panel 31 that is configured by two glass plates sandwiching liquid crystal in between, and polarization plates (polarization filters) 32 and 33 for restricting the oscillation of optical wave to a given direction, which are each laminated on each glass plate of the liquid crystal panel 31. The liquid crystal display device includes peripheral members (not shown in the figure) such as an LSI (Large Scale Integration) for driving.

The liquid crystal panel 31 includes various components not shown in the figure. For example, the two glass plates have display electrodes, active elements such as a thin film transistor (TFT), liquid crystal, a spacer, sealant, an orientation film, a common electrode, a protective film, a color filter, and others, none of which is shown in the figure.

Incidentally, the structural unit of the backlight device 10 is selected in an arbitrary way. For example, the unit including only the backlight frame 11 with the LED substrate 12 may be called as the “backlight device (backlight)” and distributed so as not to include the laminated body of the optical films such as the diffusion plate 13 and the prism sheets 14 and 15.

FIG. 2 is a view for explaining a partial structure of the backlight device 10. In an instance shown in FIG. 2, a direct-lighting type backlight configuration is adopted in which light sources are disposed directly beneath the rear of the liquid crystal display module 30. In this backlight configuration, LED chips are arrayed in such a manner that they are almost uniformly distributed over the entire rear surface of the liquid crystal display module 30. The instance is different from what is called a side-lighting type in which light sources are placed along one or two sides of a light guide plate and uniform light on a plane surface is obtained by a reflecting plate, the light guide plate and the like.

The backlight frame 11 has a chassis structure made of, for example, aluminum, magnesium, iron, or a metallic alloy including these materials. To the inside of the chassis structure, a polyester film or the like having a high performance of reflecting white light is adhered, for example. The polyester film also functions as a reflector. The chassis structure is composed of a rear portion corresponding to the size of the liquid crystal display module 30 and side portions enclosing the four sides of the rear portion. On the rear portion or the side portions, a heat sink configuration including a cooling fin for exhaust heat may be provided as necessary.

In the instance shown in FIG. 2, the plural LED substrates 12 (eight LED substrates 12 in the instance shown in FIG. 2) are disposed. The LED substrates 12 are fixed to the backlight frame 11 by plural screws 17, respectively. On each of the LED substrates 12, plural light-emitting diodes (LEDs) 21 are disposed. On the surface thereof, white resist is applied, in order to secure reflectance of, for example, 80% or more. The light emitting diodes (LEDs) 21 include a red light-emitting diode, a green light-emitting diode, and a blue light-emitting diode that emit red, green and blue light, respectively. Moreover, the red, green and blue light-emitting diodes are disposed according to a given rule. Mixing the light emitted from these red, green and blue light-emitting diodes allows a light source to have a wide color reproduction range. Further, the plural LED substrates 12 are attached to the backlight frame 11, and thereby the light-emitting diodes (LEDs) 21 are uniformly distributed in the whole structure of the backlight. By this configuration, there is provided a backlight device achieving preferable color mixing and evenness of brightness and of chromaticity by using entire light-emitting diodes (LEDs) 21 existing in the backlight frame 11. Incidentally, in the instance shown in FIG. 2, plural LED substrates 12 are disposed. However, instead of this, there may be used a single LED substrate 12 on which all light-emitting diodes (LEDs) 21 used as light sources of the backlight are disposed.

Also, each individual light-emitting diode (LED) 21 disposed on the LED substrate 12 is provided with a cap 50. The cap 50 is a hemispherical member including a lens unit that transmits light and a reflector unit that reflects light, and is fixed on the LED substrate 12 so as to cover each individual light-emitting diode (LED) 21. As will be described later, the cap 50 functions as a reflector that reflects light in a predetermined range on the side on which the LED substrate 12 is fixed, and has the cap function of transmitting light from this portion to its vertex.

A description will be given with regard to hitherto adopted technology to facilitate an understanding of the present exemplary embodiment.

FIGS. 6A and 6B are views for explaining a method for forming a reflector and a cap, the adoption of which has been heretofore discussed. As shown in left-hand drawings of FIGS. 6A and 6B, a LED 202 is formed on a LED substrate 201, and the LED 202 is connected to circuit (not shown in the figure) on the LED substrate 201 by a wire 203. Then, around the LED 202 on the LED substrate 201, a reflector 204 about, for example, 1 mm high is formed in circular form surrounding the LED 202. Potting, bonding, printing or other methods are used to form the reflector 204 on the LED substrate 201.

With reference to FIG. 6A, a cap 205 made of, for example, a transparent resin is prepared separately. The cap 205 has, in part, a hemispherical shape, and has a dome shape formed by hollowing it, and the cross-sectional profile of the dome coincides with the size of the reflector 204. Then, as shown in the right-hand drawing of FIG. 6A, the cap 205 is bonded to the reflector 204 formed on the LED substrate 201. On this occasion, a liquid resin 206 such as liquid silicone is filled into space covered with the cap 205.

On the other hand, in FIG. 6B, a resin with high viscosity is potted on the LED 202, and a cap 210 as shown in right-hand drawing of FIG. 6B is formed.

The method shown in FIGS. 6A and 6B requires another process for the formation of the reflector 204 in the formation of the LED substrate 201. Also, the method shown in FIG. 6A requires the bonding of the cap 205 to the reflector 204, and has difficulty in positioning and also difficulty in fixing the cap 205. Further, the method shown in FIG. 6b also has the problem of having great difficulty in controlling the formation of the cap 210, because potting is used for the formation of the cap 210.

The inventors have devised the cap 50 shown in FIGS. 3A and 3B as the result of their efforts to address the above problems.

FIGS. 3A and 3B are views for explaining the structure of the cap 50 to which the exemplary embodiment is applied. FIG. 3A is a perspective view of the cap 50 as seen from above when placed with its end 55 in contact with a horizontal surface. Also, FIG. 3B is a vertical sectional view of the cap 50 taken through its top 54 when placed with its end 55 in contact with the horizontal surface. As shown in FIGS. 3A and 3B, the cap 50 has the hollow dome shape, and has a lens portion (or a light transmission portion) 51 of, for example, hemispherical shape, made of a transparent resin, which is formed at the side where the top 54 is located. Also, a reflector portion (or a light reflection portion) 52 made of a white resin is formed at the end 55 of the dome shape. Incidentally, a resin containing metallic powder such as silver may be used in place of the white resin.

More specifically, as shown in FIG. 3B, the reflector portion 52 is formed with a predetermined width w from the end 55 of the dome shape in a ceiling direction A. Also, the lens portion 51 is formed in the ceiling direction A of the dome shape, being continuous with the reflector portion 52 of the width w. Two gate traces 53, for example, are left around the boundary between the lens portion 51 and the reflector portion 52. The value of the width w from the end 55 is determined according to the height of the light-emitting diode (LED) 21 on the LED substrate 12, when the end 55 is in contact and adhesively bonded to the LED substrate 12.

Preferably, when the height of the light-emitting diode (LED) 21 being a light-emitting element is set equal to 0.1 mm, for example, and the value of the width w is set to 10 to 20 times the height of the light-emitting diode (LED) 21 (between 1 and 2 mm inclusive), light emitted from the light-emitting diode (LED) 21 is efficiently used as a backlight. As mentioned above, the width w may be defined according to the height of the light-emitting diode (LED) 21. On the other hand, as other references, the value of the width w may be designed to be less than ½ of the diameter of the cap 50, thereby allowing the application of direct light of an angle wider than about 45 degrees, of light from the light-emitting diode (LED) 21, to the lens portion 51.

Also, resin materials for the lens portion (or the light transmission portion) 51 and the reflector portion (or the light reflection portion) 52 include a thermosetting resin such as a silicone resin or an epoxy resin, and a thermoplastic resin such as a polycarbonate resin or a cyclic olefine polymer. The thermoplastic resin is preferable because it is capable of facilitating two-color molding by injection molding. The thermoplastic resin includes, for example, a methacrylate resin or a polycarbonate resin that is lightweight and excellent in transparency and heat resistance, a cyclic olefine polymer typified by Zeonex (registered trademark), and a polymer composition having other polymers combined therewith. Other polymers include the above resins, a known styrene-based resin, an acrylic resin, and a polycarbonate resin.

As a molding resin, the above resins may be used singly, or two or more types of the above resins may be blended for use. Also, mica, talc, a glass filler, or the like may be added for the purpose of controlling mechanical strength or molding shrinkage factor for the injection molding, or of preventing the occurrence of a burr or a warp.

The resin for the reflector portion (or the light reflection portion) 52 may be obtained by mixing one or more kinds of filler such as titanium oxide, zinc oxide or barium sulfate into the above transparent resin. Although the form of the filler is not specifically limited, the filler in bead, fiber or other forms may be used. The amount of filling is appropriately selected according to molding conditions such as a resin molding method or resin flow ability, or according to characteristics such as reflectance or mechanical strength, and 2 wt % to 60 wt % is generally preferable.

Incidentally, the preferable values of the transmittance and reflectance of the lens portion (or the light transmission portion) 51 that is a first resin layer and the reflector portion (or the light reflection portion) 52 that is a second resin layer may be defined, using total transmittance and total reflectance based on the testing method for optical properties according to JISK7105. For example, preferably, light transmittance of the lens portion (or the light transmission portion) 51 is equal to or more than 80%, or more preferably equal to or more than 70%. Also, preferably, the total reflectance of the reflector portion (or the light reflection portion) 52 is equal to or more than 60%. Adoption of such transmittance and reflectance allows achieving good focusing and output of light for use in the backlight device 10.

Incidentally, the hemispherical shape shown in FIGS. 3A and 3B may be adopted as the external shape of the cap 50; however, other than that, any of various cubes or the like may be adopted as the external shape. Also, a shape of sawtooth, a shape of funnel, or the like may be adopted. Preferably, the cap 50 has the opening end 55 so as to be attached to the LED substrate 12. The end 55 may be bent like a brim of a hat. Preferably, the cap 50 also has a predetermined ceiling structure, as a dome shape, for achieving diffusion of light to the liquid crystal display module 30 (refer to FIG. 1) disposed in the ceiling direction A. The cap 50 also has a hollow portion for attaching the light-emitting diode (LED) 21 that is the solid-state light-emitting element. After the attachment of the cap 50 to the LED substrate 12, a thermosetting transparent resin, for example, is injected into the hollow portion. The injection of the transparent resin allows the protection of the light-emitting diode (LED) 21 and also allows prevention of the attached cap 50 from moving.

Here, in the reflector portion (or the light reflection portion) 52, a reflecting film may be used on a resin surface to further increase the reflectance.

Metal or an inorganic compound may be used as the reflecting film by using a known process such as a dry process or a wet process. For example, metal such as gold, silver, platinum, nickel, titanium or aluminum, or an oxide or nitride of these metals may be formed as the reflecting film on the resin surface of the reflector portion (or the light reflection portion) 52 by using CVD, vacuum evaporation, sputtering or other methods.

Incidentally, the film thickness of the reflecting film may be set such that sufficient reflection occurs, and the reflecting film may be formed of a single layer or a multilayer construction having a combination of several layers and preferably has a thickness of 10 nm to several hundreds nm.

FIG. 4 is a view showing an LED light source with the cap 50 attached to the LED substrate 12. On the LED substrate 12, the light-emitting diode (LED) 21 is provided as mentioned above, and the light-emitting diode (LED) 21 is connected by a wire 22 to a pad 23 on the LED substrate 12. The cap 50 is adhesively bonded to the LED substrate 12 by an adhesive layer 24 formed on the end 55 shown in FIGS. 3A and 3B. In the bonding, the cap 50 is placed so that the light-emitting diode (LED) 21 is substantially concentric with the cap 50. Various adhesives such as a silicone-based adhesive or an epoxy adhesive may be employed as the adhesive layer 24. The provision of the adhesive layer 24 in a lower portion (namely, the end 55) of the reflector portion 52, that is a white part, facilitates fixing the cap 50 on the LED substrate 12.

Also, a second transparent resin 25 for protecting the light-emitting diode (LED) 21 and also for transmitting light is formed in a void formed by adhesively bonding the dome-shaped cap 50 to the LED substrate 12 through the adhesive layer 24. A predetermined thermosetting resin is used for the second transparent resin 25, and the resin is injected in liquid form into the void through a resin injection port 26 and is then cured. By this curing, the resin is filled into the void between the cap 50 and the LED substrate 12 and into the resin injection port 26. Any given resin may be used for the second transparent resin 25; however, it is required that the resin be resistant to deterioration due to heat or light from the light-emitting diode (LED) 21 and be excellent in weather resistance. For example, silicone or the like having heat resistance and light resistance is used. Incidentally, the resin injection port 26 penetrates through a surface of the LED substrate 12 opposite to a mounting surface of the light-emitting diode (LED) 21 and a region of the mounting surface in which the void is formed.

Here, when the light-emitting diode (LED) 21 emits light in the LED light source configured as shown in FIG. 4, the liquid crystal display module 30 (refer to FIG. 1) is irradiated from a backside surface thereof with emitted light exiting through the second transparent resin 25 and the lens portion 51. On the other hand, light entering the reflector portion 52 of the cap 50 turns into reflected light, which is then used for irradiation of the liquid crystal display module 30 from the backside surface thereof through the lens portion 51. As mentioned above, the reflector portion 52 that forms a white portion of the cap 50 functions as the reflector to reflect the light from the light-emitting diode (LED) 21, the reflected light from the LED substrate 12 or the like.

A description will be given with regard to a method of manufacturing the LED light source shown in, for example, FIG. 4.

FIGS. 5A to 5C are views for explaining the method of manufacturing the LED light source (or the backlight device). As shown in FIG. 5A, the cap 50 and the LED substrate 12 are first prepared. The LED substrate 12 has the light-emitting diode (LED) 21 mounted thereon. Also, as mentioned above, the cap 50 has the dome shape having the hollow portion, as the external shape, and has the reflector portion 52 having high reflectance, formed with the predetermined width from the end of the external shape (namely, the end 55 shown in FIGS. 3A and 3B), and the lens portion 51 continuous with the reflector portion 52.

Then, as shown in FIG. 5B, the cap 50 is bonded and fixed onto the LED substrate 12, with its end on top of the LED substrate 12 (that is, on the side on which the light-emitting diode (LED) 21 is placed), in such a manner that the light-emitting diode (LED) 21 is located substantially at the center of the hollow portion. This fixing is accomplished by the adhesive layer 24 made of the silicone-based adhesive, the epoxy adhesive or the like. When the cap 50 is fixed on the LED substrate 12, the void is formed by the hollow portion of the cap 50 and the LED substrate 12. The light-emitting diode (LED) 21 is present in this void.

Then, as shown in FIG. 5C, a thermosetting liquid resin (or fluid resin), for example, is injected through the resin injection port 26 into the void formed by the hollow portion of the cap 50 and the LED substrate 12. Then, the liquid resin is cured to yield the LED light source (or the backlight device).

A description will be given of a method of manufacturing the cap 50.

A known injection molding method or injection molding machine may be used for cap (or lens) molding. An injection apparatus or a mold clamping apparatus that constitutes the injection molding machine may be appropriately selected according to the shape or productivity of the cap 50, and the arrangement of the injection apparatus and the mold clamping apparatus is not specifically limited. Also, molding conditions for a molding process may be selected according to the type of molding machine for use, the shape of the cap, or the like.

When the injection molding machine is used for the molding process, it is preferable that the temperature of the resin is higher than the glass transition temperature of the resin, and it is preferable that the temperature of the mold is in the vicinity of the glass transition temperature or lower. In particular, when an optical lens requires surface accuracy, it is effective that the temperature of the mold is set higher than a typical temperature of the mold in order to improve surface transfer characteristics.

Further, a known steel material may be used for an injection mold, and the surface of the mold may be coated with a material such as titanium, chromium or carbon according to the purpose such as wear resistance or lens surface accuracy. Also, if it is required to form a pattern or the like on the surface of the lens, a pattern of a desired shape may be formed on the inner surface of the mold by sandblasting, etching, electrocasting method, or the like.

Also, the gate shape of the mold is not limited, and a known method such as a direct gate or a pin gate may be used according to the shape of the cap.

Further, a known method such as an ejection method using a pin or the like or a method using air or the like to float the cap off may be used as a method for removing the cap from the mold.

FIGS. 7A to 7E are views showing an example of the method of manufacturing the cap 50. Here, a molding machine having two injection apparatuses (namely, a primary mold and a secondary mold) is used for the molding of the cap 50. A mold part includes a moving mold (or a common mold) that forms the outer surface of the cap, a fixed mold (or the primary mold) that is disposed facing the moving mold and forms the inner surface of a transparent portion (namely, the lens portion 51), and a fixed mold (or the secondary mold) that forms the outer and inner surfaces of a reflecting layer (namely, the reflector portion 52).

The moving mold is moved relative to the fixed molds (or the primary and secondary molds) by a driving mechanism (not shown in the figure) to form, in its clamped position, a cavity according to the shape of a lens part. A fluid resin or liquid resin obtained by melting a solid resin typically in pellet form is injected and filled into the cavity through a nozzle (not shown in the figure). Then, the molding resin is cooled, and is removed from the mold, for example, by pushing out a pin provided on the moving mold. A two-color cap is manufactured by injecting a reflecting resin into the cavity formed by the primary mold and the common mold shown in FIGS. 7A to 7E.

This molding procedure will be described in further detail with reference to FIGS. 7A to 7E. First, a first molding step involves clamping the primary mold, and injecting the transparent resin (or a first liquid resin) (refer to FIG. 7A). Then, a second molding step involves opening the primary mold, and then rotating the common mold on the core side (refer to FIG. 7B). Then, a third molding step involves clamping the secondary mold and injecting the reflecting (or white) resin (or a second liquid resin having higher light reflectance than that of the first liquid resin) (refer to FIG. 7C). Incidentally, at this time, the clamping of the primary mold and the injection of the transparent resin performed at the first molding step also take place. Then, a fourth molding step involves opening the secondary mold, and then removing the cap 50 (refer to FIG. 7D). Then, the common mold on the core side is rotated (refer to FIG. 7E), and the third molding step shown in FIG. 7C and the following steps are repeated. By such steps, obtained is the cap 50 on which the reflector portion (or the light reflection portion) 52 having the light reflection function, and the lens portion (or the light transmission portion) 51 toward the ceiling direction of the dome shape continuous and integral with the reflector portion 52 are formed.

As described in detail above, the present exemplary embodiment allows simplification of the manufacturing process for the backlight device 10, and also facilitates bonding of the LED substrate 12 and the cap 50. Also, the injection of the silicone resin generally having weak adhesion to the LED substrate 12 into the void of the cap 50, for example, allows achieving a long lifetime and also providing the LED light source having a high degree of light output efficiency.

Further, this allows increasing the positioning accuracy of the cap 50 and the light-emitting diode (LED) 21, thus providing the backlight device 10 with high quality.

### BRIEF DESCRIPTION OF THE DRAWINGS

FIG. 1 is an entire configuration of a liquid crystal display device to which an exemplary embodiment is applied;

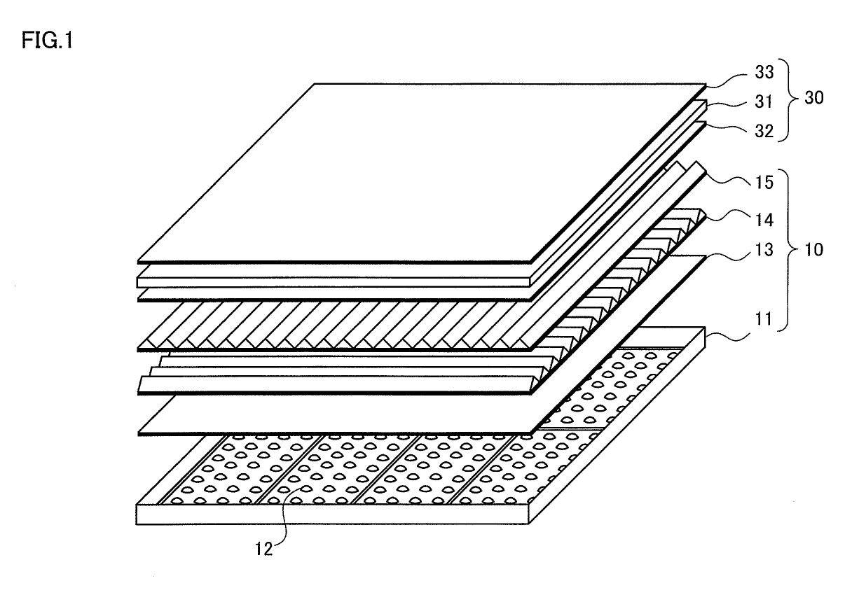

FIG. 2 is a view for explaining a partial structure of the backlight device;

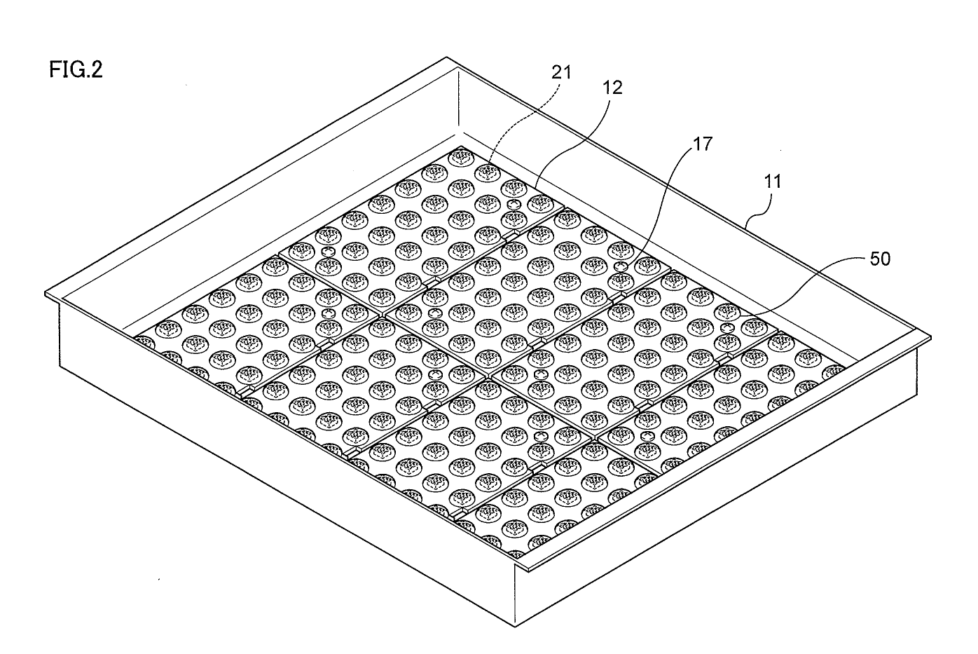

FIGS. 3A and 3B are views for explaining the structure of the cap to which the exemplary embodiment is applied;

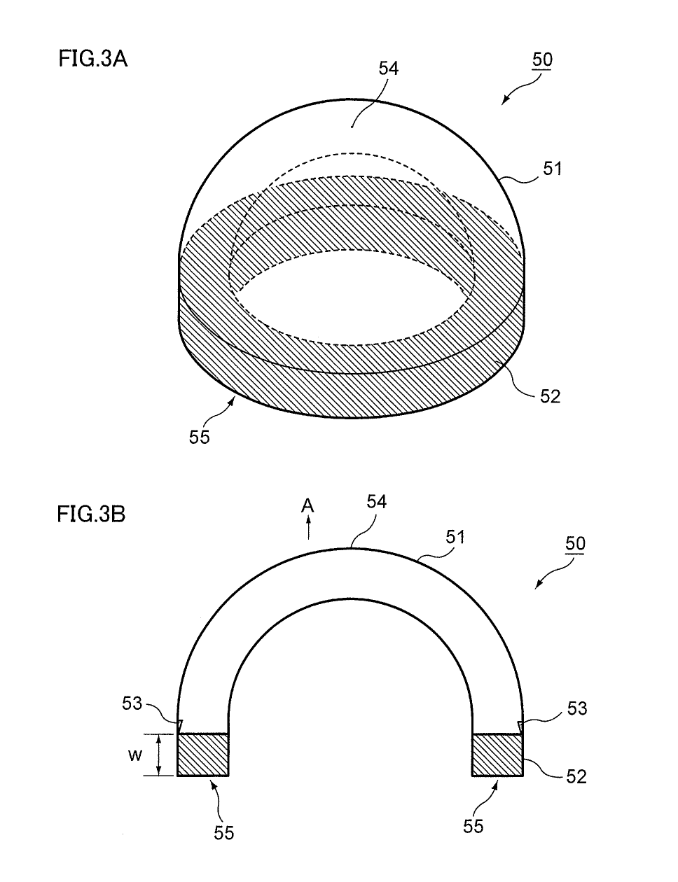

FIG. 4 is a view showing an LED light source with the cap attached to the LED substrate;

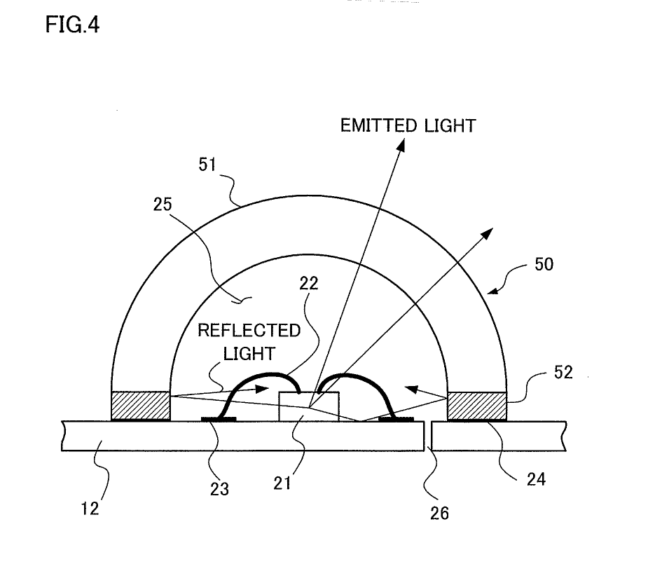

FIGS. 5A to 5C are views for explaining the method of manufacturing the LED light source (or the backlight device);

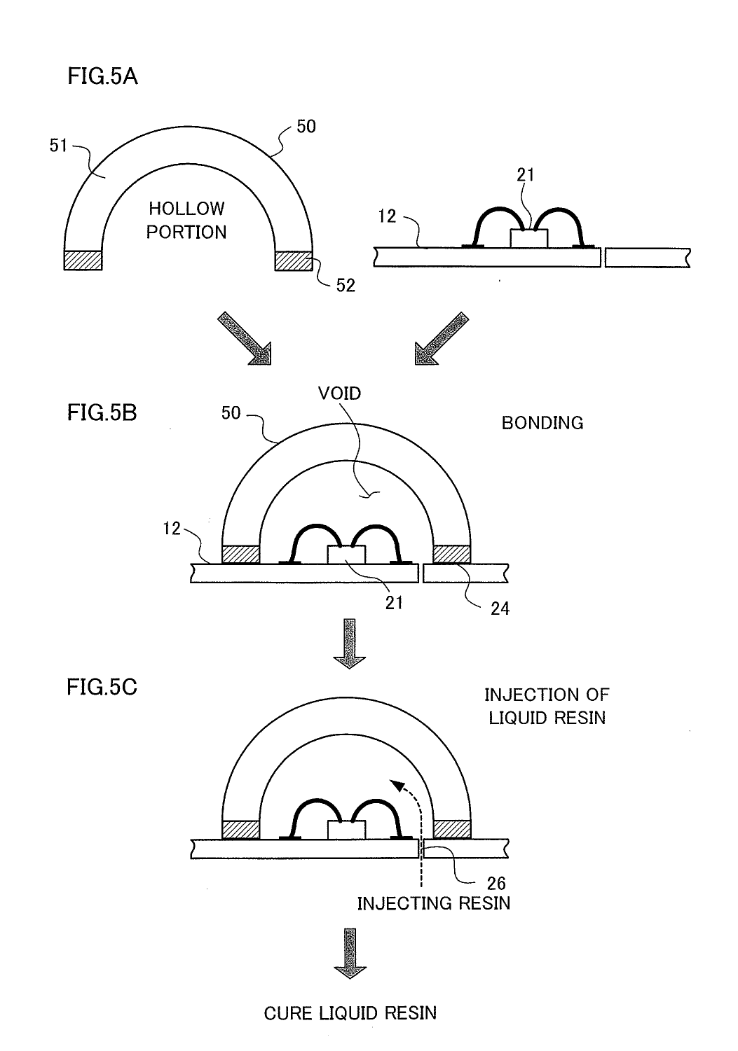

FIGS. 6A and 6B are views for explaining a method for forming a reflector and a cap, the adoption of which has been heretofore discussed; and

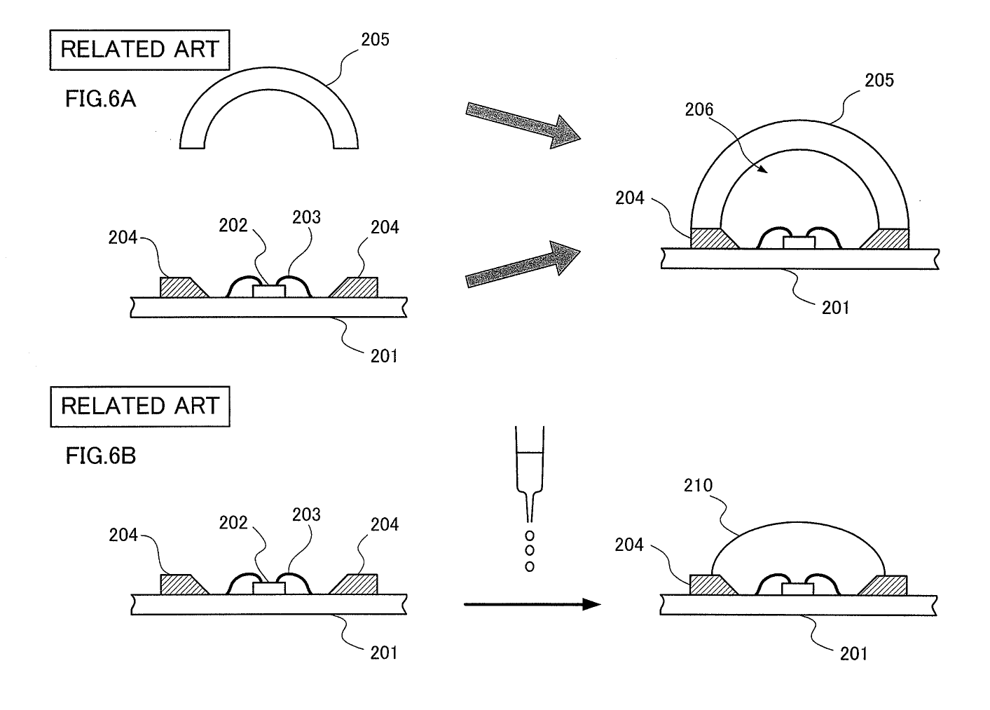

FIGS. 7A to 7E are views showing an instance of the method of manufacturing the cap.

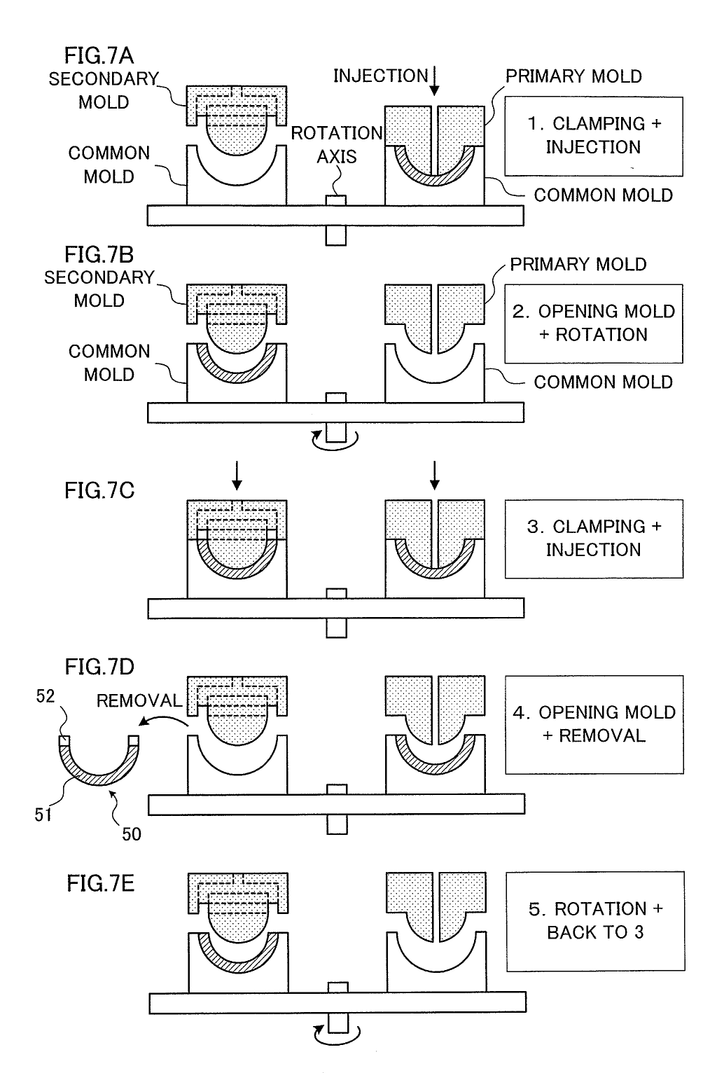

### DESCRIPTION OF REFERENCE NUMERALS AND SIGNS

10 . . . backlight device (backlight), 11 . . . backlight frame, 12 . . . LED substrate (mounting substrate), 13 . . . diffusion plate, 14, 15 . . . prism plate, 21 . . . light-emitting diode (LED), 50 . . . cap, 51 . . . lens portion (light transmission portion), 52 . . . reflector portion (light reflection portion), 55 . . . end

1. A display device including a display panel that displays an image, and a backlight disposed on a back side of the display panel and irradiating the display panel with light from the back side of the display panel, wherein
the backlight comprises:
a solid-state light-emitting element; and
a cap that covers the solid-state light-emitting element, and
the cap has a light reflection portion that reflects light from the solid-state light-emitting element, and a light transmission portion that transmits light from the solid-state light-emitting element toward the display panel, the light reflection portion and the light transmission portion being integral with each other.

2. The display device according to claim 1, wherein the cap forms a dome shape having an end and a ceiling, the light reflection portion is provided to have a width from the end of the dome shape, and the cap is mounted on a mounting substrate with the end of the dome shape fixedly bonded to the mounting substrate on which the solid-state light-emitting element is mounted.

3. A cap having an opening end and a ceiling, and forming a hollow shape, comprising:
a light reflection portion that is provided to have a width from the end toward the ceiling; and
a light transmission portion that is provided toward the ceiling, and that is continuous with the light reflection portion.

4. The cap according to claim 3, wherein the light reflection portion is made of a white resin, the light transmission portion is made of a transparent resin having a light transmittance of 80% or more, and the white resin and the transparent resin are formed integrally with each other.

5. A light-emitting device comprising:
a mounting substrate;
a solid-state light-emitting element that is mounted on the mounting substrate; and
a cap that is attached to the mounting substrate and that covers the solid-state light-emitting element, wherein
the cap has a light reflection portion of a width from a side of the cap, the side being attached to the mounting substrate, and has a light transmission portion continuous with the light reflection portion, the light reflection portion and the light transmission portion formed integrally with each other.

6. The light-emitting device according to claim 5, wherein the light reflection portion of the cap is provided with a reflection film.

7. The light-emitting device according to claim 5, wherein
a plurality of the solid-state light-emitting elements are mounted on the mounting substrate, and
the cap is attached to each of the plurality of the solid-state light-emitting elements.

8. The light-emitting device according to claim 5, wherein
a plurality of the solid-state light-emitting elements are mounted on the mounting substrate, each solid-state light-emitting element having, as a unit, at least three LEDs (light-emitting diodes) included in a plurality of LEDs each emitting red, green, or blue light, and
the cap is attached to each unit of the solid-state light-emitting elements having at least the three LEDs as the unit.

9. A method of manufacturing a backlight device, comprising:
placing a cap on a mounting substrate having a solid-state light-emitting element mounted thereon, with its end in contact with the mounting substrate, the cap having, as an external shape, a dome shape with a hollow portion, and having a light reflection portion that reflects light from the solid-state light-emitting element and a light transmission portion that transmits light from the solid-state light-emitting element, the light reflection portion and the light transmission portion being integral with each other, the light reflection portion having high reflectance with a width from an end of the external shape; and
injecting a curing liquid resin into a void formed by the hollow portion of the cap and the mounting substrate, and then curing the liquid resin.

10. The method of manufacturing the backlight device according to claim 9, wherein the injection of the liquid resin is performed through a resin injection port penetrating a surface of the mounting substrate opposite to a mounting surface on which the solid-state light-emitting element is mounted and a region of the mounting surface where the void is formed, and the liquid resin, including the resin within the resin injection port, is cured.

11. A method of manufacturing a cap for covering a solid-state light-emitting element, comprising:
forming a light transmission portion that forms a hollow and that has a ceiling and an end by injecting a first liquid resin into a mold; and
forming a light reflection portion continuous with the end of the light transmission portion by injecting, into a mold, a second liquid resin having higher light reflectance than the first liquid resin after forming the light transmission portion, thereby forming the cap having the light reflection portion that reflects light from the solid-state light-emitting element and the light transmission port ion that transmits light from the solid-state light-emitting element, the light reflection portion and the light transmission portion being integral with each other.
